(19) United States
(12) Patent Application Publication
(10) Pub. No.: US 2014/0025392 A1
(43) Pub. Date: Jan. 23, 2014

(54) Systems and Methods for Validating Treatment Instructions

(71) Applicant: CURLIN MEDICAL INC., East Aurora, NY (US)

(72) Inventor: Sreelal Chandrasenan, San Diego, CA (US)

(73) Assignee: Curlin Medical Inc., East Aurora, NY (US)

(21) Appl. No.: 13/835,967

(22) Filed: Mar. 15, 2013

Related U.S. Application Data
(60) Provisional application No. 61/673,125, filed on Jul. 18, 2012.

(51) Int. Cl. G06F 19/00

(52) U.S. Cl. CPC G06F 19/3481; G06F 19/325
USPC 705/2

(57) ABSTRACT

The present invention can be described as systems and methods for validating treatment instructions. The system may comprise a server having a library database and an agency interface configured to receive medical treatment guidelines and store medical treatment guidelines in the library database. The system may also comprise an administrative console, a processor and a medical device. The processor is configured to validate a treatment instruction of the medical device based on the medical treatment guidelines in the library database. As a method, the present invention receives updated medical information and a treatment instruction of the medical device. Using the processor the treatment instruction is validated based on the medical information of the library database and a validation message is transmitted to the medical device.

### CROSS-REFERENCE TO RELATED APPLICATIONS

This application claims priority to U.S. Provisional Application No. 61/673,125, filed on Jul. 18, 2012, now pending, the disclosure of which is incorporated herein by reference.

### FIELD OF THE INVENTION

The invention relates to validating medical treatment instructions, for example, validating treatment instructions used by a medical device.

### BACKGROUND OF THE INVENTION

According to an Institute of Medicine report, medical errors are estimated to result in approximately 44,000 and 98,000 preventable deaths and 1,000,000 excess injuries each year in U.S. hospitals alone. In another study conducted by the Agency for Healthcare Research and Quality, approximately 7,000 people were estimated to die each year from medication errors and over 180,000 people die each year partly as a result of iatrogenic injury.

Generally, a medical error occurs when a health-care provider chose an inappropriate method of care or the health provider chose the right solution of care but executed it incorrectly. Medical errors are often described as human errors in healthcare.

Multiple methods have been established to reduce medical errors. In the specific area of medication errors, previous attempts focused on the creation of a Dose Error Reduction System (“DERS”). Typically, a DERS has a server for storing drug databases (also referred to as “drug libraries.”) The DERS communicates information from the drug libraries to medical devices, such as infusion pumps, configured to communicate with the DERS and store the drug library information in the infusion pump. In the past, a DERS might also include a DERS editor which is used by clinicians and pharmacists to create and/or manage each drug library. Some medical devices operate independently of any DERS, but nevertheless store a drug library.

Currently, most DERSs and medical devices do not contain any information about drug recalls or drug adverse effects. For example, pharmacists or clinicians need to manually remove or disable the drug from the DERS drug libraries when there is a recall. Similarly, the drug libraries in stand-alone medical devices do not have a mechanism for checking drug recalls or adverse reactions, and must be manually updated. If clinicians need to check the active ingredients for a specific National Drug Code (NDC), that information is not available in the DERS database or medical device drug library.

### BRIEF SUMMARY OF THE INVENTION

The present invention may be described as a system for validating treatment instructions. The system comprises a server. The server has a library database and an agency interface. The agency interface is configured to receive medical treatment guidelines and store medical treatment guidelines in the library database. The agency interface may be configured to receive medical treatment guidelines through an RSS feed. The medical treatment guidelines may be received from a publishing agency, such as the U.S. Food and Drug Administration. The medical treatment guidelines may comprise dosage guidelines.

The system also comprises an administrative console. The console is in electronic communication with the library database and configured to allow an administrator to maintain the library database using the console.

In addition to the administrative console and the server, the system also comprises a medical device and a processor. The medical device may be an infusion pump. The medical device may also be a tablet computer. The processor is in electronic communication with the library database and the medical device. The processor is also configured to validate a treatment instruction of the medical device based on the medical treatment guidelines in the library database. The medical device may also have a display configured to output a result of the validation performed by the processor.

In one embodiment, a system of the present invention may further comprise a patient information database in communication with the processor. The patient information database has patient medical information about one or more patients. A target patient is identified using the medical device and the processor validates a treatment instruction of the medical device based on the medical treatment guidelines in the library database and the patient medical information of the target patient.

The present invention may also be described as a method for electronically validating treatment instructions of a medical device using a processor. The processor may be in electronic communication with a library database, and the library database has medical information. The method comprises the steps of receiving, at the library database, updated medical information (from a publishing agency); receiving, at the processor, a treatment instruction of the medical device; validating, using the processor, the treatment instruction based on the medical information of the library database; and transmitting a validation message to the medical device. The step of receiving updated medical information may be performed periodically, on demand, or be triggered by an external event.

In one embodiment, the treatment instruction may include a patient identifier of a target patient, and the step may further comprise retrieving patient medical information related to the target patient based on the received patient identifier. In some embodiments the validation step is also based on the retrieved patient medical information.

The invention can also be described as a method for electronically validating treatment instructions of a medical device using a processor. In such a method, the medical device has a display. The method comprises the steps of receiving a treatment instruction and a patient identifier from a user; transmitting the treatment instruction and patient identifier to the processor; and receiving validation information from the processor. The validation information may include a validation code and information for display on the medical device. The method may further comprise displaying the validation information on the display of the medical device; and operating the medical device based on the validation code.

In one embodiment, the method may further comprise the steps of receiving a medication identifier and transmitting the medication identifier to the processor. In another embodiment, the method may further comprise receiving a device identifier and transmitting the device identifier to the processor.

One embodiment of the present invention may be described as a system and method to keep the drug libraries in a DERS and/or a medical device up to date with drug recalls and adverse drug reaction advisories. Various governmental and private agencies periodically publish information and alerts about adverse drug reactions and drug recalls. These agencies also provide database systems and servers to make this information available to the public. This embodiment provides mechanisms to bring public information about drug recalls and adverse drug reactions to a DERS system and medical devices so that it will make a DERS more useful, and make the medical devices safer to use. Also, this embodiment improves workflow for pharmacists and clinicians who, until now, were required to update the DERS with current clinical practice information. In addition, medical devices, such as infusion pumps, can check an online database and/or enterprise servers of the public agencies and inform the clinician about any drug recalls or drug adverse reactions prior to, or during, the infusion programming.

### DESCRIPTION OF THE DRAWINGS

For a fuller understanding of the nature and objects of the invention, reference should be made to the following detailed description taken in conjunction with the accompanying drawings, in which:

FIG. 1 is a schematic of a system according to one embodiment of the present invention;

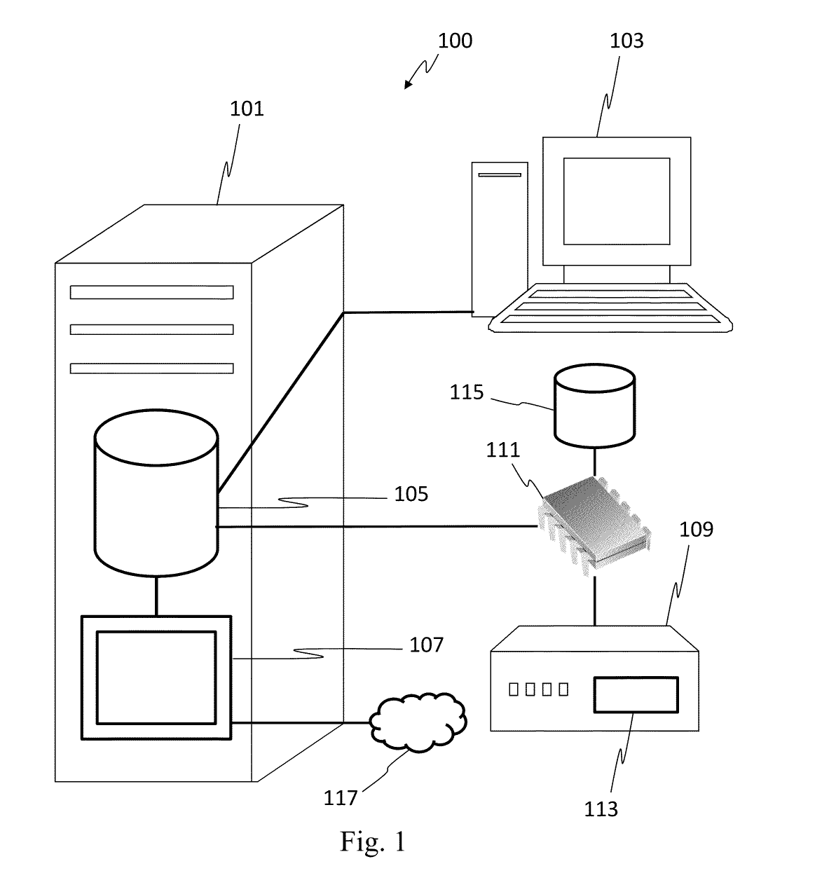

FIG. 2 is a flowchart of a method according to one embodiment of the present invention;

FIG. 3 is a flowchart of a method according to one embodiment of the present invention;

FIG. 4 is a schematic of a system according to one embodiment of the present invention;

FIG. 5 is a block diagram of a medical device formed in accordance with an embodiment of the present invention; and

FIG. 6 is an illustration of a drug update prompt according to an embodiment of the present invention.

### DETAILED DESCRIPTION OF THE INVENTION

In one embodiment, the invention can be described as a system for validating treatment instructions. Treatment instructions may describe a variety of medical treatments. For example, treatment instructions may include doses of medication to be delivered to a patient, a physical therapy routine for rehabilitation, a dietary plan, a surgical plan, and long-term care instructions. In one embodiment, treatment instructions may include utilizing medical devices such as infusion pumps or surgical tools. Validation refers to a comparison of the treatment instructions to known standards of care. For example, a dose of medicine may be valid when the dose falls within industry specified parameters outlining safe quantities of the medicine. Treatment instructions may be invalid when the application of such a treatment to a patient may be harmful or counterproductive. For example, an invalid treatment instruction may be an instruction to use a recalled medical device or drug, or instructions to apply a dosage of a drug that exceeds known standards of care.

In one embodiment of the present invention, the system 100 comprises a server 101. As known to one skilled in the art, a server is a physical computer dedicated to run one or more services to serve the needs of the users of other computers on the network. The server 101 may be located within a hospital or other medical practice. In some embodiments, the server 101 may be centralized to run services in many hospitals or medical practices. The server 101 is capable of communication with other computers and the Internet, for example, through an Ethernet connection. The server has a library database 105. The library database 105 is, for example, a drug library that contains medical treatment guidelines for the application of drugs to a patient. The library database 105 may also be a device library that contains the recall status of certain medical devices. The library database 105 may be a compilation of one or more medical treatment guideline databases. For example the library database 105 may be a combination of a drug library and a device library. The library database 105 may be an enterprise database created and maintained by a medical practice group.

The server 101 also has an agency interface 107. The agency interface 107 is configured to receive medical treatment guidelines. For example, the agency interface 107 may be a program that utilizes a processor in communication with the Internet. The program may monitor RSS feeds from a variety of medical treatment guideline sources 117. One source 117 may be the U.S. Food and Drug Administration. For example, the U.S. Food and Drug Administration releases information about medical device recalls, drug recalls, or new treatments. The agency interface 107 may also monitor alerts sent over e-mail or received via fax. The agency interface 107 may perform data processing on the received medical treatment guidelines to remove extraneous information and standardize the information for storage in a library database 105. The agency interface 107 may store received medical treatment guidelines in the library database 105. The agency interface 107 may add metadata to the medical treatment guidelines so the guidelines can be better organized. For example, the agency interface 107 may add source, date, and severity metadata. In another example, the agency interface 107 may categorize the received guidelines based on the drug, device, or treatment plan to which the guidelines pertain.

The system 100 may also comprise an administrative console 103. The administrative console 103 may also reside on the server 101 or be embodied as a separate computing device. For example, the administrative console 103 may be a computer terminal operated by the medical administration in a hospital. In another embodiment, the administrative console 103 may be available as a web based application available to authorized users. The administrative console 103 is in electronic communication with the library database 105. For example, the administrative console 103 may be in electronic communication through Ethernet or the Internet.

The administrative console 103 is configured to allow an administrator to maintain the library database 105 using the console 103. For example, the administrative console 103 may allow an administrator to add or remove medical treatment guidelines in the database 105. The administrator may also edit existing guidelines to remove, add, or clarify the guidelines. In one embodiment, each medical treatment guideline received by the agency interface 107 must be reviewed by an administrator using the administrative console 103 before the medical treatment guideline is stored in the library database 105 or is allowed to be read from the database 105.

The system 100 may also comprise one or more medical devices 109. The medical devices 109 may include infusion pumps, monitors, hand held computers, mobile phones, tablet computers, and other devices used to deliver or enable treatment instructions. In some embodiments, the server 101 may be housed within the medical device 109.

The system 100 may also comprise a processor 111 in electronic communication with the library database 105 and the medical device 109. The processor 111 may be a dedicated microprocessor or a program configured to operate using a microprocessor. The processor 111 may be located at the server 101, on a separate server, in the medical device 109, or in a combination of these locations. The processor 111 is configured to validate a treatment instruction of the medical device 109 based on the medical treatment guidelines in the library database 105. Validation may be performed by comparing an input treatment instruction with the medical treatment guidelines in the library database 105. For example, the library database 105 may contain a range of acceptable dosages for the administration of a drug in an infusion pump. The treatment instructions inputted into the infusion pump are validated by comparing the inputted treatment instructions with the range stored in the library database 105. If the inputted treatment instructions are within the range, the instructions are valid and the pump may be instructed to begin infusion. Otherwise, the pump may require a physician override to being treatment or prevent the treatment entirely. Treatment instructions need not only come from medical devices 109 delivering treatment. Treatment instructions may be inputted by, for example, a pharmacist at a clinic pharmacy or by a doctor on his mobile computing device.

In one embodiment, the system 100 may further comprise a patient information database 115. The patient information database 115 may contain medical information correlated to specific patients. For example, the patient information database 115 may store vital statistics about a user such as height, weight, and blood type. The patient information database 115 may also store allergy information for specific patients. In some embodiments, the patient information database 115 may contain a partial or full medical history of a specific patient. The patient information database 115 is configured to make a specific patient's medical information retrievable through use of a personal identifier, such as a patient name, number, Social Security number, address, or combination thereof. The information may be categorized such that specific pertinent features of the medical information may be rapidly accessed.

The patient information database 115 may also be stored on the server 101. Regardless, the patient information database 115 is in communication with the processor 111. A target patient is identified using the medical device 109. For example, a clinician may input identifying information for the target patient into the medical device 109. In other embodiments, the medical device 109 may capture the target patient's identification information. For example, the target patient may be identified with a bar code reader (reading an identifying tag given to the patient) or through a biometric device such as a fingerprint reader. In embodiments with a patient information database 115, the processor may validate treatment instructions based on both the medical treatment guidelines in the library database 105 and the patient medical information of the target patient from the patient information database 115. In this way, the system 100 may prevent the administration of treatment that is within acceptable dosage parameters, but cause a known adverse reaction with a specific patient. In other embodiments, the result of validation may be varied based on the a specific care area, for example, neo-natal, in addition to, or in lieu of, the information of a target patient.

In some embodiments, the medical device 109 has a display 113 configured to output a result of the validation performed by the processor 111. For example, the result of the validation may be a message informing the user of the medical device 109 that the treatment has been validated or found invalid. The output of the validation may be an audio chime or an audio message. The output of the validation may also be further instructions for the operator of the device 109 based on the information in library database 105. For example, the result of the validation may be a checklist for a patient or other user operating the medical device 109 of vital information that should be confirmed or recorded before the treatment instructions are started. In other embodiments, the result of the validation may include pointers (such as hyperlinks) to additional information or reports regarding the treatment instructions. In another embodiment, the pointers may include an option to contact a responsible clinician to gain approval for the treatment instructions.

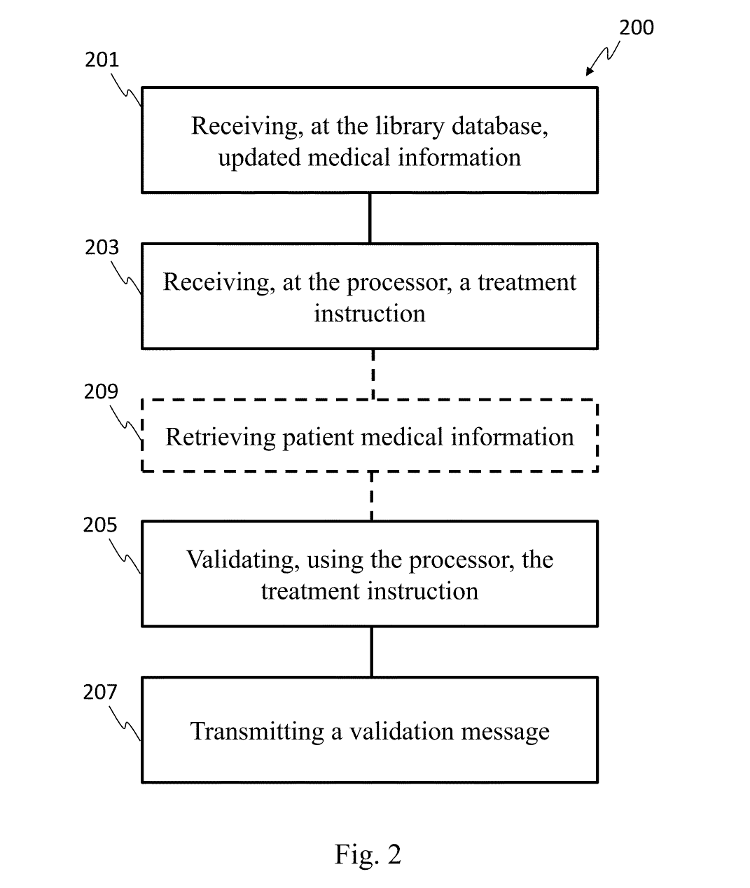

The invention may also be described as a method 200 for electronically validating treatment instructions using a processor in electronic communication with a library database, as shown in FIG. 2. The library database contains medical information, such as medical guideline information. The treatment instructions may be sent from or sent to a medical device.

The method 200 comprises the step of receiving 201, at the library database, updated medical information. This step 201 may be performed periodically, such as daily, in order to receive the latest medical information. This step 201 may also be performed on demand by a user or be triggered by an electronic event, such as receiving an e-mail or detecting an update in an external database or RSS feed. The medical information may be received from an agency, such as the U.S. Food and Drug Administration.

The method 200 further comprises the step of receiving 203, at the processor, a treatment instruction of the medical device. The treatment instruction may be received 203 from the medical device itself or the treatment instruction may be intended for the medical device but received from another source, such as a doctor's computer or the pharmacy. The treatment instruction may be received 203 via the Internet or an intranet exclusive to a treatment instruction validation signal. The treatment instruction may also be received 203 locally (if the processor is housed within the medical device) or over a local area network.

The method 200 further comprises the step of validating 205, using the processor, the treatment instruction based on the medical information of the library database. Validation 205 refers to a comparison of the treatment instructions to known standards of care. For example, a dose of medicine may be valid when the dose falls within industry specified parameters outlining safe quantities of the medicine. Treatment instructions may be invalid when the application of such a treatment to a patient may be harmful or counterproductive. For example, an invalid treatment instruction may be an instruction to use a recalled medical device or drug, or instructions to apply a dosage of a drug that exceeds known standards of care.

The method 200 further comprises the step of transmitting 207 a validation message to the medical device. The validation message may include a message informing the user of the medical device that the treatment has been validated or found invalid. The validation message may be an audio chime or an audio message. The validation message may also be further instructions for the operator of the device based on the information in library database. For example, the validation message may be a checklist for a patient or other user operating the medical device of vital information that should be confirmed or recorded before the treatment instructions are started.

In another embodiment, the treatment instruction may include a patient identifier for a target patient. The patient identifier may be a patient ID number, name, Social Security number, address, or a combination thereof. In such an embodiment, the method may further comprise the step of retrieving 209 patient medical information related to the target patient based on the received patient identifier. For example, patient medical information may be retrieved 209 from a patient medical information database by searching the database for records related to the patient identifier. In some embodiments, the validation step 205 discussed above is performed using retrieved 209 patient medical information. In this way, validation 205 can be performed using established medical guidelines and patient medical information, for example, checking to make sure a dosage is within an acceptable range, and that the patient is not allergic to the medication.

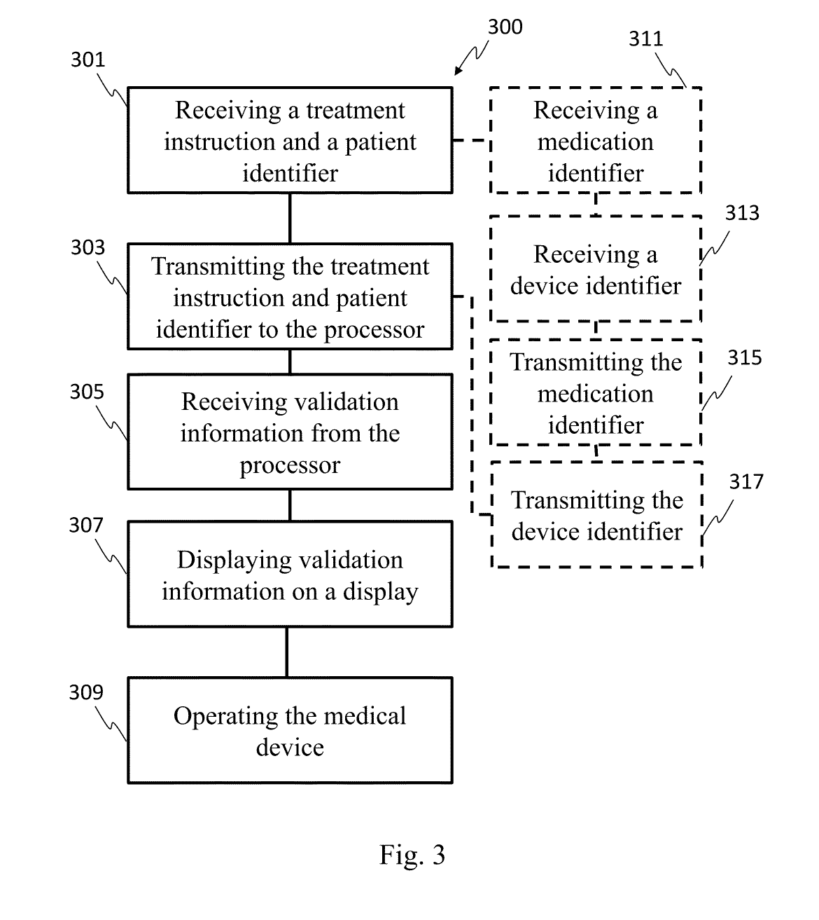

The present invention may also be described as a method 300 for electronically validating treatment instructions of a medical device using a processor, as shown in FIG. 3. In some embodiments, the medical device has a display. One embodiment of the method includes receiving 301 a treatment instruction and a patient identifier from a user. The treatment instruction and patient identifier is transmitted 303 to the processor. The processor may be located in the medical device or at a remote device, such as a server. Validation information including a validation code is received 305 from the processor, and the validation information comprises information for display on the medical device. The validation information is displayed 309 on the display of the medical device, and the medical device is operated 309 based on the validation code.

In one embodiment, the method 300 further comprises the steps of receiving 311 a medication identifier and transmitting 315 the medication identifier to the processor. The medication identifier may be an National Drug Code (NDC) identifier. The medication identifier may also include information identifying the specific batch of the medication and its source or age.

In another embodiment, the method 300 further comprises the steps of receiving 313 a device identifier and transmitting 317 the device identifier to the processor. In this way, the validation step 307 can return the proper validation information based on the status of the identified device. For example, the validation information may include a validation code stating that the treatment instructions are invalid because the identified device has been recalled or has expired.

The present invention may also be used to implement a continuous quality improvement (CQI) system. CQI is a theory-based system that seeks to improve the provision of services with an emphasis on future results. Like total quality management, CQI uses a set of statistical tools to understand subsystems and uncover problems, but its emphasis is on maintaining quality in the future, not just controlling a process. Once a process that needs improvement is identified, a team of knowledgeable individuals is gathered to research and document each step of that process. Once specific expectations and the means to measure them have been established, implementation aims at preventing future failures and involves the setting of goals, education, and the measurement of results. If necessary, the plan may be revised on the basis of the results, so that the improvement is ongoing.

The validation aspect of the present invention can also encompass CQI. For example, an administrator may identify areas of weakness and add pertinent goals, education, and measurements to the library database. In this way, when a problematic treatment instruction is received at the processor, the processor can respond with a result of the validation that attempts to alleviate treatment problems. For example, if keeping accurate records of a patient's blood pressure and pulse were problematic for a particular organization, the result of the validation may include a reminder to the clinician to check and records the patient's blood pressure and pulse before beginning the treatment instructions. In other words, the present invention can be used as a feedback system to implement CQI.

This invention may be embodied as a method to communicate from the DERS and/or medical devices to a national drug code directory servers) maintained by the FDA and/or other agencies. Communications may be made periodically, in order to get up to date information about drug recalls and adversary alerts. Users may be provided with the notifications or prompts such that the users (typically pharmacists and clinicians) are informed about the drug reaction and drug recalls pertaining to drug library entries in the DERS, and also in the medical devices. Providing this information at the DERS will create a safer DERS than the current approach which requires manual procedures. The present invention also helps the DERS confirm the dosage and active ingredients for a drug identified by NDC. Similar advantages are realized for medical devices directly receiving updates.

Thus, the present invention may allow hospitals to detect drugs which are recalled and take necessary steps to prevent use of a recalled drug. Similarly, the present invention can help patients using medical devices, such as infusion pumps, in ambulatory or home environments by providing more immediate notifications about new drug recalls and adverse reaction warnings.

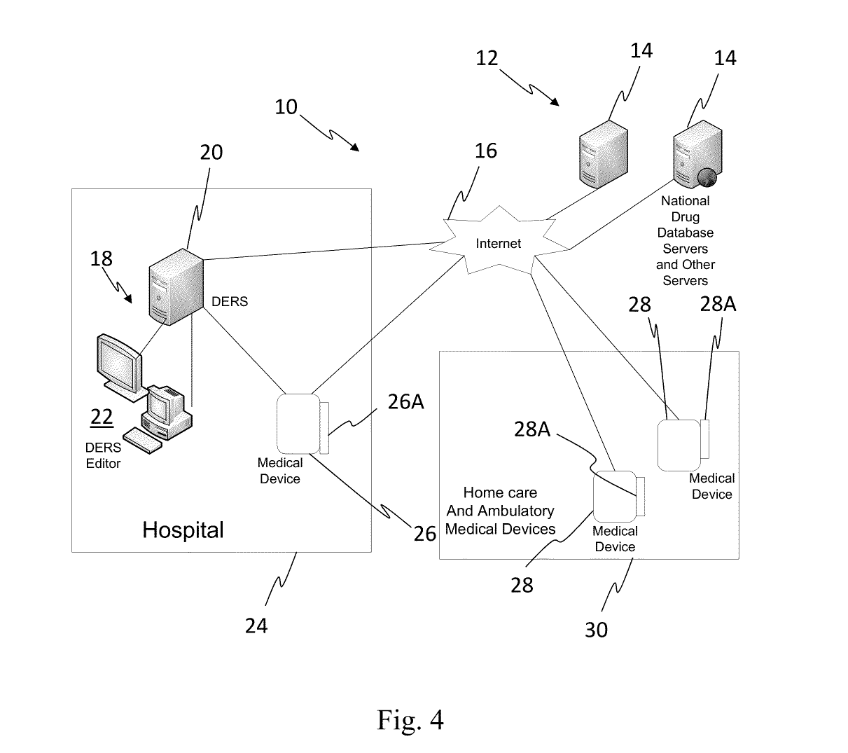

FIG. 4 shows a schematic illustrating a system 10 formed in accordance with an embodiment of the present invention. System 10 comprises one or more publicly accessible drug database systems 12 including drug database servers 14 storing information and transmitting alerts regarding adverse drug reactions, drug recalls, and drug safety protocols. By way of non-limiting example, the United States Food and Drug Administration (FDA) manages a database named Drugs@FDA, a database named Recalls, Market Withdrawals, & Safety Alerts, a database named Drug Recalls, and a database named Postmarket Drug Safety Information for Patients and Providers. The FDA also provides an e-mail subscription service that sends an e-mail message to a subscriber each time there is an update on the FDA website page(s) selected by the subscriber. Sources other than the FDA may be used, such as the Mayo Clinic website.

System 10 may comprise a DERS 18 including at least one DERS server 20 and at least one DERS editor 22 in communication with the DERS server 20. DERS 18 may be found, for example, in a hospital or clinical environment 24. DERS 18 communicates with medical devices 26 having memory 26A for storing control instructions and drug library information. As indicated schematically in FIG. 4, DERS server 20 may be configured to communicate with medical devices 26. System 10 may also comprise medical devices 28 operated in a home care or ambulatory setting 30. Each medical device 28 has memory 28A for storing control instructions and drug library information. In accordance with an embodiment of the present invention, DERS servers 20 and medical devices 26 and 28 are configured to communicate with drug database servers 14 of publicly accessible drug database system 12 via the Internet 16.

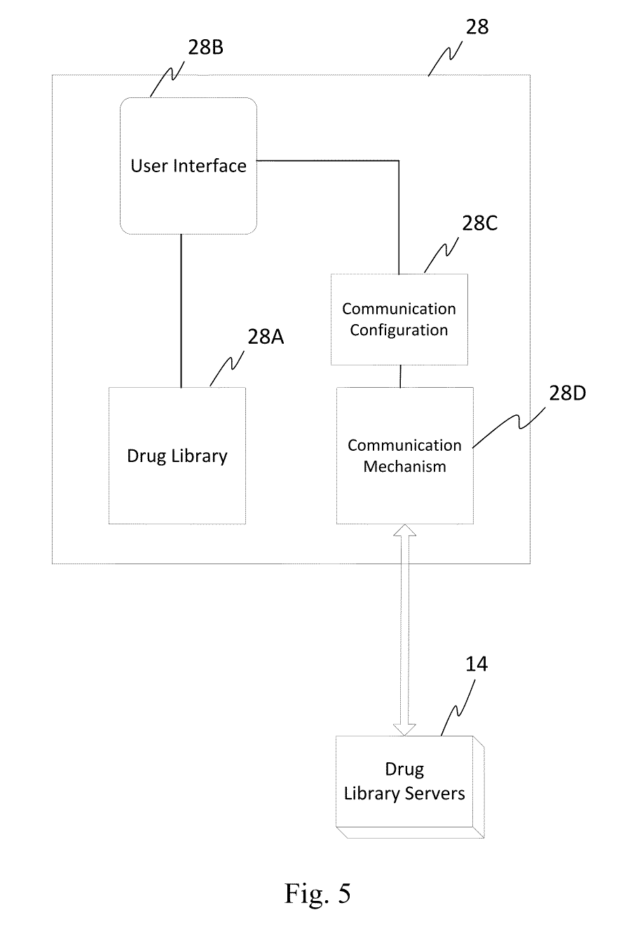

FIG. 5 is a schematic block diagram showing medical device 28 such as a drug infusion pump in greater detail. As mentioned above, medical device 28 includes memory 28A storing a drug library. Medical device 28 may also include a user interface 28B such as a touch screen and/or keypad input for enabling a user to program the medical device, for example by choosing a drug delivery protocol stored in the drug library. Medical device 28 may further include a communication configuration 28C and an associated communication mechanism 28D enabling medical device 28 to communicate with public drug database servers 14. Communication configuration 28C may be, for example, a stand-alone memory, such as a subscriber identity module (SIM) card, containing instructions that enable the medical device to communicate over a GSM network. The communication configuration 28C may also be instructions, stored in a separate or shared memory in communication with the medical device 28, such as an SSID, username, and password for Wi-Fi communication. Communication mechanism 28D may be, for example, an antenna for wireless communication (GSM, Wi-Fi, etc.), a data port for wired communication (Ethernet, USB, etc.), or an optical receiver/transmitter (infrared, etc.) As may be understood, DERS servers 20 and medical devices 26 may be configured for communication with public drug database servers 14 in a similar manner.

In accordance with the present invention, DERS 18 and medical devices 28 are configured to communicate with drug database servers 14 of one or more publicly accessible drug database systems 12 to get updates on drug recalls and drug alerts. Various communication technologies may be used for this purpose, including Internet and intranet protocols, cellular technologies, e-mail protocols, SMS, Twitter, RFID, and AM/FM radio frequencies. Integration of DERS servers 10 with public drug database servers 14 may be achieved using database queries, subscription with RSS, email notifications, and/or other web services technologies (e.g. SOAP, REST), and/or by filtering contents from FDA recall reports and safety alerts.

DERS 18 may be configured to automatically update the recall information and dose alerts in DERS servers 20 using information received from public drug database servers 14.

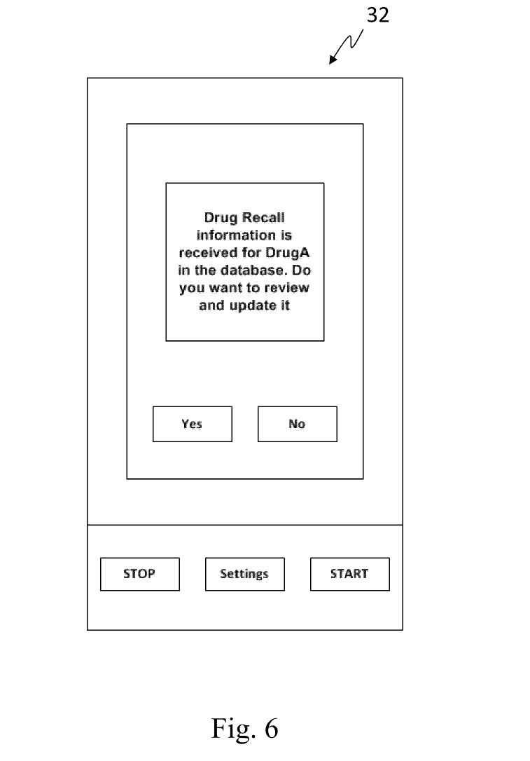

FIG. 6 illustrates an example of a drug update prompt 32 that may be displayed at DERS editor 22 and/or at user interface 28B of medical device 28. When new information is received concerning a drug in a stored drug library, the user is notified and prompted to input a command determining whether to start updating the drug library with the new information. It is also contemplated to provide a “postpone and remind” option, whereby the user can postpone updating the drug library for a period of time and be reminded about the update at a later time.

Although the present invention has been described with respect to one or more particular embodiments, it will be understood that other embodiments of the present invention may be made without departing from the spirit and scope of the present invention. Hence, the present invention is deemed limited only by the appended claims and the reasonable interpretation thereof.

What is claimed is:

1. A system for validating treatment instructions comprising:
a server having a library database and an agency interface, the agency interface configured to receive medical treatment guidelines and store medical treatment guidelines in the library database;
an administrative console, the console in electronic communication with the library database and configured to allow an administrator to maintain the library database using the console;
a medical device; and
a processor in electronic communication with the library database and the medical device, the processor configured to validate a treatment instruction of the medical device based on the medical treatment guidelines in the library database.

2. The system of claim 1, further comprising:
a patient information database in communication with the processor, the patient information database having patient medical information about one or more patients;
wherein a target patient is identified using the medical device; and
wherein the processor validates a treatment instruction of the medical device based on the medical treatment guidelines in the library database and the patient medical information of the target patient.

3. The system of claim 1, wherein the medical device has a display configured to output a result of the validation performed by the processor.

4. The system of claim 3, wherein the medical device is an infusion pump.

5. The system of claim 1, wherein the medical treatment guidelines comprises dosage guidelines.

6. The system of claim 3, wherein the medical device is a tablet computer.

7. The system of claim 1, wherein the medical treatment guidelines are received from a publishing agency.

8. The system of claim 7, wherein the medical treatment guidelines are received from the U.S. Food and Drug Administration.

9. The system of claim 1, wherein the agency interface is configured to receive medical treatment guidelines through an RSS feed.

10. A method for electronically validating treatment instructions of a medical device using a processor in electronic communication with a library database having medical information, the method comprising the steps of:
receiving, at the library database, updated medical information;
receiving, at the processor, a treatment instruction of the medical device;
validating, using the processor, the treatment instruction based on the medical information of the library database; and
transmitting a validation message to the medical device.

11. The method of claim 10, wherein the treatment instruction includes a patient identifier of a target patient, the method further comprising the steps of:
retrieving patient medical information related to the target patient based on the received patient identifier, wherein the validation step is also based on the retrieved patient medical information.

12. The method of claim 10, wherein the step of receiving updated medical information is performed periodically.

13. The method of claim 10, wherein the updated medical information is received from a publishing agency.

14. A method for electronically validating treatment instructions of a medical device having a display using a processor, the method comprising the steps of:
receiving a treatment instruction and a patient identifier from a user;
transmitting the treatment instruction and patient identifier to the processor;
receiving validation information, including a validation code, from the processor, the validation information comprising information for display on the medical device;
displaying the validation information on the display of the medical device; and
operating the medical device based on the validation code.

15. The method of claim 14, further comprising the steps of:
receiving a medication identifier; and
transmitting the medication identifier to the processor.

16. The method of claim 14, further comprising the steps of:
receiving a device identifier; and
transmitting the device identifier to the processor.
